(19) United States
(12) Patent Application Publication
(10) Pub. No.: US 2010/0326416 A1
(43) Pub. Date: Dec. 30, 2010

(54) HIGH SPEED ABRASIVE CUTTING BLADE WITH SIMULATED TEETH

(76) Inventor: Ronald Schwarz, Livingston, NJ (US)

Correspondence Address: IM IP Law PLLC, P.O. Box 333, Hartsdale, NY, 10530, US

(21) Appl. No.: 12/867,001

(22) PCT Filed: Mar. 18, 2009
(86) PCT No.: PCT/US09/37519

§ 371 Date: Aug. 10, 2010

Related U.S. Application Data
(60) Provisional application No. 61/069,903, filed on Mar. 19, 2008.

(51) Int. Cl. B28D 1/04; B24D 18/00

(52) U.S. Cl. 125/15; 451/547; 51/309

(57) ABSTRACT

A rotary abrasive tool comprising an abrasive arranged in a predetermined pattern around a periphery of the rotary abrasive tool to simulate saw teeth, and a method of manufacturing such rotary abrasive tool Preferably, a single layer of abrasive is applied on the rotary abrasive tool. Each simulated saw tooth has a centerline which is not perpendicular to a cutting surface of the rotary abrasive tool.

### TECHNICAL FIELD OF INVENTION

The present invention relates to a high speed cutting blade, and more particularly to a high speed abrasive cutting blade with simulated teeth.

### BACKGROUND

Single layer abrasive rotary tools with continuous cutting edges are well known to those practiced in the art of abrasive tool making. These typically are made with continuous abrasive covering the outermost surface of the rotating tool. Having a continuous rim limits the ease with which cutting debris, or swarf can be evacuated from the cutting zone. Furthermore the lower force per grit that is inherent in a continuous rim tool limits the cutting rate since such tools are usually targeted at hand held tools, where the available cutting force is limited by the strength of the operator.

Many attempts have been made to eliminate these drawbacks by shaping the body of the cutting tool, either by cutting slots around the periphery of the tool (in the case of saw blades) or removing part of the body in a helical fashion in a manner that is similar to a twist drill. This approach, while somewhat effective, has several drawbacks—for example the cost of the tool body is substantially increased, due to the more complex shape, and in the case of the slotted saw blade there is a safety aspect as the slots can get “caught” in the workpiece material risking injury to the operator.

Other methods of increasing the force per grit have been disclosed, the most notable of which have been described in three patents attributed to Marcus Skeem et. al. in U.S. Pat. Nos. 6,935,940, 6,817,936, and 5,669,943. While these are all basically describing the same solution (shaping the periphery of the tool body in such a way as to present only a portion of the abrasive to the workpiece material at any one time), they all share the cost disadvantage of making a round tool body that has a convoluted periphery instead of a simple smooth circumference. In addition, no matter what shapes can be practically cut into the periphery of the tool body under these three patents, none will produce an air pumping effect to systematically evacuate swarf from the grinding zone. Indeed the purported advantages claimed in the Skeem patents were faster cut rate and longer life, as the peripherally shaped abrasive rim wears down to a smooth circular shape. However, the Skeem patents do not address increasing operator safety or promoting wider applicability. Accordingly, the present invention proceeds on the desirability of addressing these issues by providing a cutting tool comprising mixtures of abrasive to cut both concrete and steel.

The use of diamond coated and diamond impregnated bonded abrasive tools to cut stone and concrete is a common practice. However, when such a tool is used to cut through reinforced concrete or a wall containing steel retaining braces, the diamond on the tool is quickly destroyed due to the well-known dissolution and graphitization that occurs when diamond is used to cut ferrous materials. Accordingly, the present invention proceeds on the desirability of providing a cutting tool comprising mixtures of abrasive to cut both concrete and steel.

### SUMMARY OF THE INVENTION

Therefore, it is an object of the present invention to provide a high speed cutting blade which solves the aforesaid problems of the prior art.

Another object of the present invention is to provide a high speed abrasive cutting blade with simulated teeth.

In accordance with an exemplary embodiment of the present invention, the high speed abrasive cutting tool or blade utilizes mixtures of abrasive grain types, including but not limited to a proportion of abrasive material tailored to cutting ferrous metals (such as tungsten carbide or aluminum oxide) in with the diamond. This advantageously allows the cutting tool to survive contact with reinforced metal areas within the work piece which would otherwise have rapidly damaged the diamond in the cutting tool.

In accordance with an exemplary embodiment of the present invention, the abrasive is applied in a predetermined pattern onto the surface of a rotating single layer abrasive tool. The predetermined pattern of the abrasive on the claimed cutting tool simulates certain predetermined geometry and provides certain advantageous performance attributes of a cutting tool having teeth or flutes integral to the body of the cutting tool. In accordance with an aspect of the present invention, the claimed cutting tool can be made with either conventional abrasive, super-abrasive grains, or mixtures of various abrasive types. Accordingly, the claimed invention provides a new tool family which can be advantageously optimized to cut a wider range of materials quickly and safely than existing single layer cutting tools without the inventive abrasive patterning.

In accordance with an exemplary embodiment of the present invention, the abrasive on the rotating single layer abrasive tool is contained in distinct shaped areas around the periphery of the tool such that the blade of the tool appears to have teeth. These “teeth” are preferably advantageously shaped such that their centerline lies at a substantial angle to a radial straight line running from the centerline of the cutting blade to the periphery of the cutting blade. This angle has the effect of pumping air (due to the raised nature of the abrasive lands) and thus swarf away from the periphery of the tool where the grinding and cutting is taking place. Although well appreciated by those practiced in the art of making bonded tools, the efficacy of having angled grooves in the sides of an abrasive cutting tool is not generally known or appreciated by those practiced in the art of making single layer tool. In accordance with an embodiment of the present invention, the rotating single layer abrasive tool provides angled grooves without the need for expensive shaped tool bodies. That is, a cutting or saw blade in accordance an exemplary embodiment of the present invention made of simple flat sheet steel can exhibit the performance and safety advantages once available only to bonded cutting blades pressed using vary expensive high pressure high temperature presses. The cutting blades in accordance with an exemplary embodiment of the present invention can be made by coating the surface of the cutting blades with inexpensive machines and techniques as disclosed herein.

By tailoring the size of the abrasive areas compared with the “open” areas (those areas containing no abrasive at all) the balance of cutting speed and blade life can be varied over a wide range to an extent that cannot be easily achieved in a bonded diamond wheel of a conventional design. Increasing the open area proportion by the present invention allows the cutting force per grit to be increased to the point where rapid cutting can take place with noticeably lower operator effort. In accordance with an exemplary embodiment of the present invention, applying abrasive as a coating on the surface of a tool body (rather than buried in consolidated metal power as is the normal practice in diamond cutting tools) does not only reduce the complexity and cost of manufacturing the cutting tool. It also has the advantage that the abrasive protrudes from the tool surface (the so-called “grit exposure”) to a much higher degree further speeding cutting rate.

In accordance with an exemplary embodiment of the present invention, a rotary abrasive tool comprises an abrasive arranged in a predetermined pattern around a periphery of the rotary abrasive tool to simulate saw teeth. Preferably, a single layer of abrasive is applied on the rotary abrasive tool. The abrasive can be one of the following: diamond, cubic boron nitride, aluminum oxide, silicon carbide, tungsten carbide, boron carbide. In accordance with an aspect of the present invention, each simulated saw tooth has a centerline which is not perpendicular to a cutting surface of the rotary abrasive tool.

In accordance with an exemplary embodiment of the present invention, the abrasive can be applied to a body of the rotary abrasive tool by an electrodepositing at least one of the following metal: nickel, copper, tungsten, or alloys thereof. Alternatively, the metal can be deposited using an autocatalytic metal deposition process using at least one of the following metals: nickel, copper, or alloys thereof.

In accordance with an exemplary embodiment of the present invention, the abrasive can be attached to the body of the rotary abrasive tool by active brazing of any composition as known to those skilled in the art of diamond and ceramic brazing. Preferably, a metal coated abrasive can be attached to the body of the rotary abrasive tool using conventional techniques for brazing alloys as known to those skilled in the art of metal brazing.

In accordance with an exemplary embodiment of the present invention, the predetermined pattern of abrasive (i.e., a simulated saw teeth pattern of the abrasive) around the periphery of the rotary abrasive tool resembles stripes at an angle from an axis of rotation of the rotary abrasive tool. Preferably, the angle is between 0 and 90 degrees.

In accordance with an exemplary embodiment of the present invention, the abrasive is a mixture of superabrasive and non-superabrasive. The non-superabrasive being effective in grinding ferrous metals and is at least one of the following: aluminum oxide, silicon carbide, tungsten carbide, chromium carbide, or boron carbide. The superabrasive can be diamond and/or cubic boron nitride (CBN).

In accordance with an exemplary embodiment of the present invention, a percentage of the superabrasive and a percentage the non-superabrasive in the abrasive mixture can be adjusted in accordance with an application of the rotary abrasive tool (i.e., to suit a particular work piece or material to be cut, such as concrete, metal reinforced concrete, etc.) to optimize cutting speed and tool life of the rotary abrasive tool.

In accordance with an exemplary embodiment of the present invention, the width of each simulated saw tooth can be varied in accordance with an application of the abrasive tool (i.e., to suit a particular work piece or material to be cut) to optimize cutting speed and tool life of the rotary abrasive tool.

In accordance with an exemplary embodiment of the present invention, the distance between each simulated saw tooth can be varied in accordance with an application of the abrasive tool (i.e., to suit a particular work piece or material to be cut) to optimize cutting speed and tool life of the rotary abrasive tool.

In accordance with an exemplary embodiment of the present invention, the abrasive is continuous around the periphery of the rotary abrasive tool and is arranged in a predetermined pattern on each side face of the rotary abrasive tool around the periphery of said rotary abrasive tool to provide the simulated saw teeth.

In accordance with an exemplary embodiment of the present invention, a method of manufacturing a rotary abrasive tool comprises the steps of applying a single layer of an abrasive on the rotary tool such that the abrasive is arranged in a predetermined pattern around a periphery of the rotary abrasive tool to simulate saw teeth, and varying a width of the simulated saw teeth in accordance with an application of the rotary abrasive tool to optimize the cutting speed and tool life of the rotary abrasive tool. Preferably, one of following abrasive is applied to the rotary abrasive tool: diamond, cubic boron nitride, aluminum oxide, silicon carbide, tungsten carbide, boron carbide.7

Various other objects, advantages, and features of the present invention will become readily apparent from the ensuing detailed description, and the novel features will be particularly pointed out in the appended claims.

### BRIEF DESCRIPTION OF THE DRAWINGS

The following detailed description, given by way of example, and not intended to limit the present invention solely thereto, will best be understood in conjunction with the accompanying drawings in which like components or features in the various figures are represented by like reference numbers:

FIG. 1 shows a circular cutting blade in accordance with an exemplary embodiment of the present invention; and

FIGS. 2 and 3 show circular cutting blades in accordance with an exemplary embodiment of the present invention with the abrasive arranged in discrete patterns simulating saw teeth.

### DETAILED DESCRIPTION OF THE EMBODIMENTS

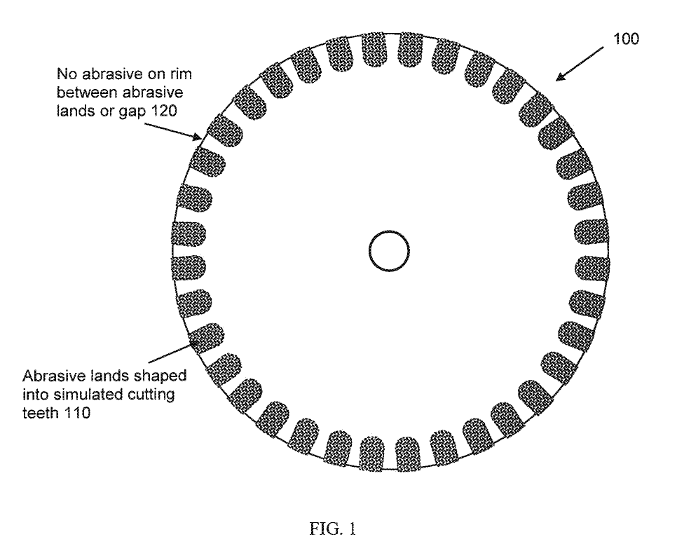

Turning now to FIG. 1, there is illustrated a circular cutting blade 100 in accordance with an embodiment of the present invention. The abrasive layer is applied in discrete shaped areas 110 in such a way as to simulate saw teeth 110. There is no abrasive on the periphery of the blade 100 between the abrasive lands 110 or gaps 120 in the circular cutting blade 100.

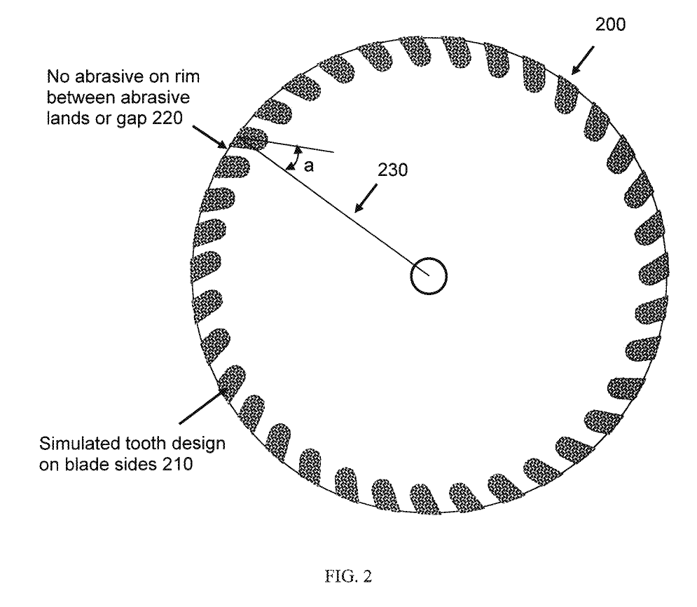

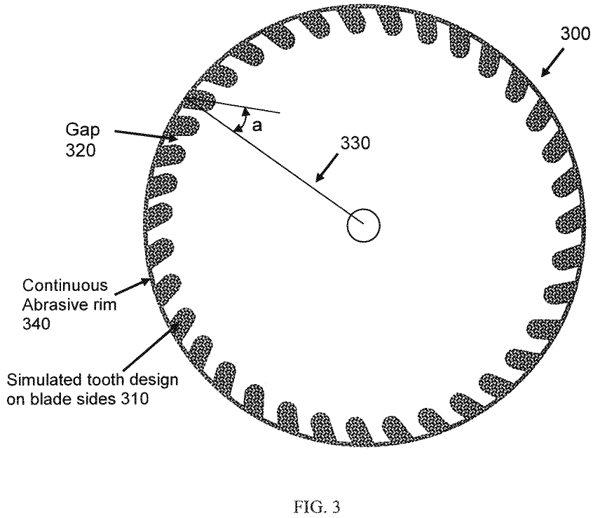

FIGS. 2 and 3 show circular cutting blades 200, 300 in accordance with embodiments of the present invention. The abrasive is arranged in discrete patterns so as to simulate saw teeth 210, 310. The simulated teeth 210, 310 are set at an angle “a” to the direction of a radial line 230, 330 emanating from the axis of rotation. FIG. 3 additional shows a circular cutting blade 300 wherein additional abrasive is affixed to the blade core material between the simulated teeth 310 or gaps 320 on the periphery of the cutting blade 300 to provide a continuous abrasive rim 340. Whereas, in FIG. 2, there is no abrasive on the periphery of the blade 200 between the abrasive lands or simulated teeth 210 or gaps 220 in the circular cutting blade 200.

### Example 1

In accordance with an embodiment of the present invention, applicant produced and tested an exemplary circular cutting blade 200 having a steel body of 178 mm diameter and 1.8 mm thickness. The exemplary circular cutting blade 200 had diamond abrasive of grit size 30/40 mesh (supplied as “ABS-3” from Saint Gobain Industrial Ceramics of Oliphant, Pa.) brazed in angled stripes 210 around the outermost 10 mm of the tool body. The stripes 210 were approximately 6 mm wide and their centerlines were angled at 30 degrees from the corresponding radial line at each stripe 210 (i.e., angle a=30°). The gap between each tooth/stripe 210 was approximately ¼″ (6.35 mm). The exemplary circular cutting blade 200 used a commercially available braze alloy comprising elemental copper powder of −325 US mesh (from US Bronze Corp., Flemington, N.J.), tin powder of −325 US mesh (from US Bronze Corp., Flemington, N.J.) and titanium hydride powder of −230 US mesh from Sumitomo Corporation of Japan. Preferably, these copper, tin and titanium hydride powders were mixed in the proportions 77/23/10, respectively, and vacuum brazed at a temperature between 870 and 890 Celsius.

The cutting performance of the exemplary circular cutting blade 200 of the claimed invention was compared in cutting through concrete paving slabs, with a commercially available bonded dry cutting diamond blade purchased from Lowes Home Center in Hackettstown, N.J. It was found that the exemplary cutting blade 200 of the claimed invention cut up to 40% faster than the conventional bonded diamond blade. The exemplary cutting blade 200 of the claimed invention was also found to be capable of cutting through PVC pipe and siding, concrete backerboard, ceramic tile and plastic composite decking material.

### Example 2

In accordance with an embodiment of the present invention, applicant produced and tested a second exemplary circular cutting blade 200 of the claimed invention having a steel body of 178 mm diameter and 1.8 mm thickness. The exemplary circular cutting blade 200 had mixed abrasive of grit size 30/40 mesh (applied as an approximately 50/50 mixture of “ABS-3” diamond and crushed tungsten carbide grain supplied by Material Specialties Scandinavia, Virginia Beach, Va.) brazed in angled stripes 210 around the outermost 10 mm of the tool body. The stripes 210 were approximately 6 mm wide and their centerlines were angled at 30 degrees from the corresponding radial line at each stripe 210 (i.e., angle a=30°). The gap between each tooth/stripe 210 was approximately ¼″ (6.35 mm).

The cutting performance of this second exemplary cutting blade 210 of the claimed invention cutting the same workpiece materials described in Example 1 herein was not found to be degraded by the dilution of the diamond abrasive with the softer carbide abrasive. The introduction of the ferrous-capable abrasive gave the second exemplary cutting blade 210 of the claimed invention the added advantage of being able to cut through steel-containing concrete, and even small pieces of angle iron or iron pipe. Accordingly, the non-superabrasive grain thus protects the diamond from the rapid wear that a 100% diamond blade would experience.

While the best overall test results were achieved with a 50/50 diamond to tungsten carbide ratio, tests were conducted with other ratios of diamond to tungsten carbide, such as 25/75 and 75/25 diamond to tungsten carbide ratios. The claimed invention also contemplates the use of these and other ratios of superabrasive and non-superabrasive grains to make the cutting blades in accordance with an embodiment of the present invention.

Tests were also conducted with teeth/stripes 210 that were narrower (e.g., 25%) than those initially tested, with the initial tools being tested with a tooth/stripe thickness of ¼″ (6.35 mm). Using narrower teeth/stripes 210 without increasing the number of teeth/stripes 210, applicant found that this effectively increases the distance or gap between the teeth/stripes 210, thereby decreasing the total number of abrasive grains.

The cutting speed of the tool can be increased (i.e., faster cutting speed), but with a corresponding reduction in overall tool life by reducing the following three variables: (1) the number of diamond grains by adding secondary abrasives, (2) the number of diamond grains by utilizing narrower teeth/stripes, and (3) the number of diamond grains by utilizing wider spacing of the teeth/stripes, the cutting speed can be increased with a corresponding reduction in overall tool life. The cutting speed of the tool can be reduced (i.e., slower cutting speed) with a corresponding increase in the overall tool life by increasing the following three variables: (1) the number of diamond grains by reducing the amount of secondary abrasives, (2) the number of diamond grains by utilizing wider teeth/stripes, and (3) the number of diamond grains by utilizing narrower spacing of the teeth/stripes. Accordingly, the force per grit decreases (as does the cutting speed) as the distance between the diamond grains decreases, and the opposite is equally true.

In accordance with an embodiment of the present invention, applicant has developed and manufactured cutting blades for various applications incorporating this information. That is, the cutting blade of the claimed invention incorporates different mixture of abrasives depending on the application and/or materials to be cut. The claimed invention incorporates a greater number of diamond grains to assure acceptable tool life for applications involving hard materials, such as a granite and concrete. Whereas, for softer materials (such as plastics or composites), the claimed invention incorporates a design employing few diamond grains to obtain cutting blades with a faster cutting speed and still have acceptable tool life. If a “general purpose” cutting tool is desired, then a 50/50 mixture, with a ¼″ (6.35 mm) tooth/stripe width was seen to be the optimal design at the time of applicant's testing of the claimed invention.

While the present invention has been particularly described with respect to the illustrated embodiments, it will be appreciated that various alterations, modifications and adaptations may be made based on the present disclosure, and are intended to be within the scope of the present invention. It is appreciated that although the invention has been described with respect to derivative securities with any number of components, the disclosed invention may be similarly applied to derivative securities with one or more components. It is intended that the appended claims be interpreted as including the embodiments discussed above, the various alternatives that have been described, and all equivalents thereto.

1. A rotary abrasive tool comprising an abrasive arranged in a predetermined pattern around a periphery of said rotary abrasive tool to simulate saw teeth.

2. The tool of claim 1, wherein the abrasive applied on said rotary abrasive tool is a single layer.

3. The tool of claim 1, wherein the abrasive is at least one of the following: diamond, cubic boron nitride, aluminum oxide, silicon carbide, tungsten carbide, boron carbide.

4. The tool of claim 1, wherein each simulated saw tooth has a centerline which is not perpendicular to a cutting surface of said rotary abrasive tool.

5. The tool of claim 2, wherein said abrasive is applied to a body of said rotary abrasive tool by electrodepositing at least one of the following metals: nickel, copper, tungsten, or alloys thereof.

6. The tool of claim 2, wherein said abrasive is applied to a body of said rotary abrasive tool by an autocatalytic metal deposition process using at least one of the following metal: nickel, copper, or alloys thereof.

7. The tool of claim 2, wherein said abrasive is applied to a body of said rotary abrasive tool by an active brazing.

8. The tool of claim 7, wherein said abrasive is a metal coated abrasive that is applied to said body of said rotary abrasive tool by brazing alloys.

9. The tool of claim 2, wherein said predetermined pattern around said periphery of said rotary abrasive tool resembles stripes at an angle from an axis of rotation of said rotary abrasive tool, wherein said angle is between 0 and 90 degrees from said axis of rotation.

10. The tool of claim 1, wherein said abrasive is a mixture of superabrasive and non-superabrasive effective in grinding ferrous metals; wherein said non-superabrasive is at least one of the following: aluminum oxide, silicon carbide, tungsten carbide, chromium carbide, or boron carbide; and wherein said superabrasive is at least one of the following: diamond or cubic boron nitride.

11. The tool of claim 10, wherein a percentage of said superabrasive and a percentage said non-superabrasive in said mixture of said abrasive is adjusted in accordance with an application of said rotary abrasive tool to optimize cutting speed and tool life of said rotary abrasive tool.

12. The tool of claim 1, wherein a width of each simulated saw tooth is varied in accordance with an application of said rotary abrasive tool to optimize cutting speed and tool life of said rotary abrasive tool.

13. The tool of claim 1, wherein a distance between each simulated saw tooth is varied in accordance with an application of said rotary abrasive tool to optimize cutting speed and tool life of said rotary abrasive tool.

14. The tool of claim 2, wherein said abrasive is continuous around said periphery of said rotary abrasive tool and arranged in said predetermined pattern on each side face of said rotary abrasive tool around said periphery of said rotary abrasive tool to provide said simulated saw teeth.

15. A method of manufacturing a rotary abrasive tool comprising the steps of:
applying a single layer of an abrasive on said rotary tool such that said abrasive is arranged in a predetermined pattern around a periphery of said rotary abrasive tool to simulate saw teeth; and
varying a width of each simulated saw tooth in accordance with an application of said rotary abrasive tool to optimize cutting speed and tool life of said rotary abrasive tool.

16. The method of claim 15, further comprising the step of varying a distance between said each simulated in accordance with an application of said rotary abrasive tool to optimize cutting speed and tool life of said rotary abrasive tool.

17. The method of claim 15, wherein the step of applying said single layer of said abrasive applies one of the following abrasive: diamond, cubic boron nitride, aluminum oxide, silicon carbide, tungsten carbide, boron carbide.

18. The method of claim 15, wherein the step of applying said single layer of abrasive applies said abrasive in said predetermined pattern such that each saw tooth has a centerline which is not perpendicular to a cutting surface of said rotary abrasive tool.

19. The method of claim 15, wherein the step of applying said single layer of abrasive comprises the step of electrodepositing on a body of said rotary abrasive tool at least one of the following metal: nickel, copper, tungsten, or alloys thereof.

20. The method of claim 15, wherein the step of applying said single layer of abrasive comprises the step of depositing on a body of said rotary abrasive tool by an autocatalytic metal deposition process at least one of the following metal: nickel, copper, or alloys thereof.

21. The method of claim 15, wherein the step of applying said single layer of abrasive applies said abrasive in said predetermined pattern around said periphery of said rotary abrasive tool to resemble stripes at an angle from an axis of rotation of said rotary abrasive tool; and wherein said angle is between 0 and 90 degrees from said axis of rotation.

22. The method of 15, wherein the step of applying said single layer of abrasive applies a mixture of superabrasive and non-superabrasive effective in grinding ferrous metals; wherein said non-superabrasive is at least one of the following: aluminum oxide, silicon carbide, tungsten carbide, chromium carbide, or boron carbide; and wherein said superabrasive is at least one of the following: diamond or cubic boron nitride.

23. The method of claim 22, further comprising step of adjusting a percentage of said superabrasive and a percentage said non-superabrasive in said mixture of said abrasive in accordance with an application of said rotary abrasive tool to optimize cutting speed and tool life of said rotary abrasive tool.

24. The method of claim 15, wherein the step of applying said single layer of abrasive applies said abrasive such that said abrasive is continuous around said periphery of said rotary abrasive tool and arranged in said predetermined pattern on each side face of said rotary abrasive tool around said periphery of said rotary abrasive tool to provide said simulated saw teeth.

25. The method of claim 15, wherein the step of applying said single layer of abrasive comprises the step of applying said abrasive to a body of said rotary abrasive tool by an active brazing.

26. The method of claim 25, wherein the step of applying said abrasive comprises the step of applying a metal coated abrasive to said body of said rotary abrasive tool by brazing alloys.
